(19) United States
(12) Patent Application Publication
(10) Pub. No.: US 2019/0057126 A1
(43) Pub. Date: Feb. 21, 2019

(54) LOW LATENCY CONSTRAINT ENFORCEMENT IN HYBRID DBMS

(71) Applicant: International Business Machines Corporation, Armonk, NY (US)

(72) Inventors: Felix Beier, Holzgerlingen (DE); Andreas Brodt, Gerlingen (DE); Daniel Martin, Stuttgart (DE); Oliver Schiller, Dettingen/Teck (DE); Knut Stolze, Hummelshain (DE)

(21) Appl. No.: 15/679,193

(22) Filed: Aug. 17, 2017

(51) Int. Cl. G06F 17/30

(52) U.S. Cl. CPC G06F 17/30371; G06F 17/30292; G06F 17/30592; G06F 17/30368

(57) ABSTRACT

A method for enforcing constraints on a database table. The method includes: storing the database table on an analytical engine of a data processing system. An index is created on the database table on a transactional engine of the data processing system, wherein the database table stored on the analytical engine is scanned for creating the index. A data manipulation statement associated with a set of constraints on the database table is provided. The transactional engine enforces the set of constraints based on the index. In response to the set of constraints being successfully enforced: executing the data manipulation statement on the database table in the analytical engine, and updating the index in the transactional engine accordingly to the data manipulation statement.

### BACKGROUND

The present invention relates to the field of digital computer systems, and more specifically, to a method for enforcing constraints on a database table.

Database management systems (DBMS) typically offer the possibility to define constraints on the database schema to which the managed data must adhere. It is the responsibility of the DBMS to enforce the defined constraints. Whenever it executes a data manipulation statement, it must check whether the constraints are still met after the change. If the constraints are not met, then the DBMS must reject the statement. For example, unique and referential constraints are not cheap to evaluate, as they typically must search an entire table for the existence of duplicate values or the referenced key. A data manipulation language (DML) is a family of syntax elements similar to a computer programming language used for selecting, inserting, deleting and updating data in a database. Data manipulation language includes SQL data change statements (also sometimes herein referred to as database manipulation statements”), which modify stored data but not the schema or database objects.

### SUMMARY

Various embodiments provide a method for enforcing constraints on a database table, a computer program product and computer system as described by the subject matter of the independent claims. Advantageous embodiments are described in the dependent claims. Embodiments of the present invention can be freely combined with each other if they are not mutually exclusive.

According to an aspect of the present invention, there is a method for enforcing constraints on a database table. This method includes the following operations (not necessarily in the following order): (i) storing the database table on an analytical engine of a data processing system; (ii) creating an index on the database table on a transactional engine of the data processing system, wherein the database table stored on the analytical engine is scanned for creating the index; (iii) providing a data manipulation statement associated with a set of constraints on the database table; (iv) successfully enforcing, by the transactional engine, the set of constraints based on the index; and (v) in response to the set of constraints being successfully enforced: (a) executing the data manipulation statement on the database table in the analytical engine, and (b) updating the index in the transactional engine accordingly to the data manipulation statement.

According to a further aspect of the present invention, there is a data processing system for enforcing constraints on a database table. The data processing system includes a transactional engine and an analytical engine. The data processing system is configured to perform the following operations (not necessarily in the following order): (i) storing the database table on the analytical engine; (ii) creating an index on the database table on the transactional engine, wherein the database table stored on the analytical engine is scanned for creating the index; (iii) providing a data manipulation statement associated with a set of constraints on the database table; (iv) successfully enforcing by the transactional engine the set of constraints based on the index; and (v) in response to the set of constraints being successfully enforced: (a) executing the data manipulation statement on the database table in the analytical engine, and (b) updating the index in the transactional engine accordingly to the data manipulation statement.

According to a further aspect of the present invention, there is a method, computer program product and/or computer system for performing the following operations (not necessarily in the following order): (i) storing a database table in an analytics engine of a data processing system; (ii) providing a proxy table, without including actual data in the proxy table, corresponding to the database table on a transaction engine of the data processing system; (iii) scanning the database table stored in the analytics engine to create, on the transactional engine, an index for the database table; (iv) providing a data manipulation statement that defines a set of constraint(s) on the database table; and (v) enforcing, by the transactional engine the set of constraint(s) of the database manipulation statement based on the index.

### BRIEF DESCRIPTION OF THE DRAWINGS

In the following, embodiments of the present invention are explained in greater detail, by way of example only, making reference to the drawings in which:

FIG. 1 depicts a data processing system according to an example of the present disclosure.

FIG. 2 is a flowchart of a method for enforcing constraints on a database table.

FIG. 3 is a flow diagram for an example method for enforcing a set of constraints on a database table.

### DETAILED DESCRIPTION

The descriptions of the various embodiments of the present invention will be presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The data processing system may be a hybrid DBMS or may implement a hybrid DBMS. The data processing system may herein also be referred to as a hybrid DBMS. In some embodiments, in order to address a multitude of workload types with different requirements and goals, the data processing system is composed from more than one execution engine (the transactional and analytical engines) such that each of the engines may have a respective set of resources adapted to run on the datasets. For example, the transactional engine may require less resources compared to the analytical engine as the first dataset may be smaller than the second dataset.

The data manipulation statement may encompass a database statement, such as a query. The data manipulation statement may be a data processing command For example, the data manipulation statement is a Structured Query Language (SQL) statement, which performs a write operation (INSERT, UPDATE or DELETE) in a database table. The data manipulation statement may, for example, be part of a transaction.

A “transaction” or “database transaction” is a logical unit of database operation(s) which are executed as a whole to process user requests. A “transaction” includes and frames one or more statements. As such, a “transaction” is a larger unit than a “statement” and will typically subsume multiple statements. A transaction ensures that the action of the framed statements is atomic (that is, all statements of the transaction are performed) with respect to recovery.

The constraints may, for example, include unique constraints and/or referential constraints. Unique constraints require the values in one or more columns to exist only once. Referential constraints effectively require that predetermined conditions respecting primary-to-foreign key references across tables to be met. In some embodiments, the referential constraints require that a given primary key value in a first table must really exist when a foreign key in a second table refers to it. For example, foreign key constraints involve two tables: one containing a key and a second one containing a reference to this key. Thus, in order to enforce a foreign key constraint, both tables must potentially be checked. Deletes or updates in the first table require checking the second table for dangling references. Inserts into the first table require checking the existence of the referenced key. If the two tables reside exclusively on different engines of the hybrid DBMS, then it may be impossible to enforce such foreign key constraints. While the transactional engine may be able to ask the analytical engine for the (non-) existence of a particular key value, the reverse may typically be impossible. Some embodiments of the present method may solve this problem.

Some embodiments of the present invention may enable to enforce or to check constraints defined on accelerator-only tables on the transactional engine. An accelerator-only table is a table that is stored in the analytical engine only and not stored in the transactional engine. Thus, even though the actual data of an accelerator-only table resides on the analytical engine, the transactional engine keeps and maintains the data structures (indexes) required to enforce the constraints of the accelerator-only table. As constraint enforcement consists mostly of looking up individual keys (in other words, point queries), this task is much better suited for the transactional engine than for the analytical engine that focuses on bulk workloads. Latency may be reduced by the present method as the evaluation takes place directly on the transactional engine without further redirection. Moreover, the transactional engine implements and supports the necessary data structures (indexes) and functionality. Also, cross-engine constraints can be easily enforced, as all relevant data is available on the transactional engine in a central place.

Some embodiments of the present invention may further be advantageous as there is no need to do scans of the data in the analytical engine for constraint enforcement. Furthermore, a simplification regarding implementation complexity may be achieved by reusing the existing and tuned functionality from the OLTP systems (transactional engines) instead of re-implementing it in the OLAP engine from scratch.

Some embodiments of the present invention may be advantageous as it may reduce delay in processing data manipulation compared to another approach. This, by contrast to other approaches where a data manipulation statement is received at the transactional engine, is passed on to the analytical engine, parsed, compiled and executed. The constraints are enforced, and the result is reported back to the transactional engine, which results in a lot of latency until the application is notified of the constraint violation.

Some embodiments of the present invention may be further advantageous as it may avoid creating indexes at the analytical engine specifically for this purpose of enforcing the constraints, which is expensive.

The present method may be advantageous as OLAP engines that are used as the analytical engine may not support constraints defined on accelerator-only tables.

According to one embodiment, the updating of the index is performed in response to the data manipulation statement being successfully executed. This may save resources that would otherwise be required for rolling back changes in the event of unsuccessful execution of the data manipulation statement.

According to one embodiment, the method further includes: in response to the set of constraints being successfully enforced sending by the transactional engine a request for executing the data manipulation statement to the analytical engine, wherein the execution of the data manipulation statement is performed in response to receiving the request. This may enable an efficient messaging protocol for reducing the delay in the whole execution process.

According to one embodiment of the present invention, the updating of the index is performed in parallel to the sending of the request. If the execution of the data manipulation statement is successful, this may further reduce the delay in the whole execution process.

According to one embodiment of the present invention, in the event the execution of the data manipulation statement fails, modifications done to the index can be rolled back.

According to one embodiment of the present invention, the index is implemented using a set of unique values of the database table being sufficient for enforcing the constraints. This may speed up the process of accessing, as well as updating the index, and thus the whole process may be sped up.

According to one embodiment of the present invention, the index identifies a storage location where the corresponding value is found in the database table on the analytical engine. The storage location may, for example, indicate a row, page or extent.

According to one embodiment of the present invention, the database table is stored in the analytical engine only. The database table is an accelerator only table. This embodiment may enable a seamless integration of the present method in existing systems where most of the data of a hybrid DBMS is stored as accelerator only data.

According to one embodiment, the set of constraints are on an attribute of the attributes of the database table, wherein the index includes values of the attribute only. This may speed up the process of accessing as well as updating the index and thus the whole process may be sped up.

According to one embodiment of the present invention, executing the data manipulation statement further includes committing changes caused by the execution of the data manipulation statement.

According to one embodiment of the present invention, the data processing system is a hybrid OLTP and OLAP database system wherein: (i) the transactional engine is configured for performing OLTP processes; and (ii) the analytical engine is configured for performing OLAP processes. This embodiment may seamlessly be integrated in existing data warehouse systems.

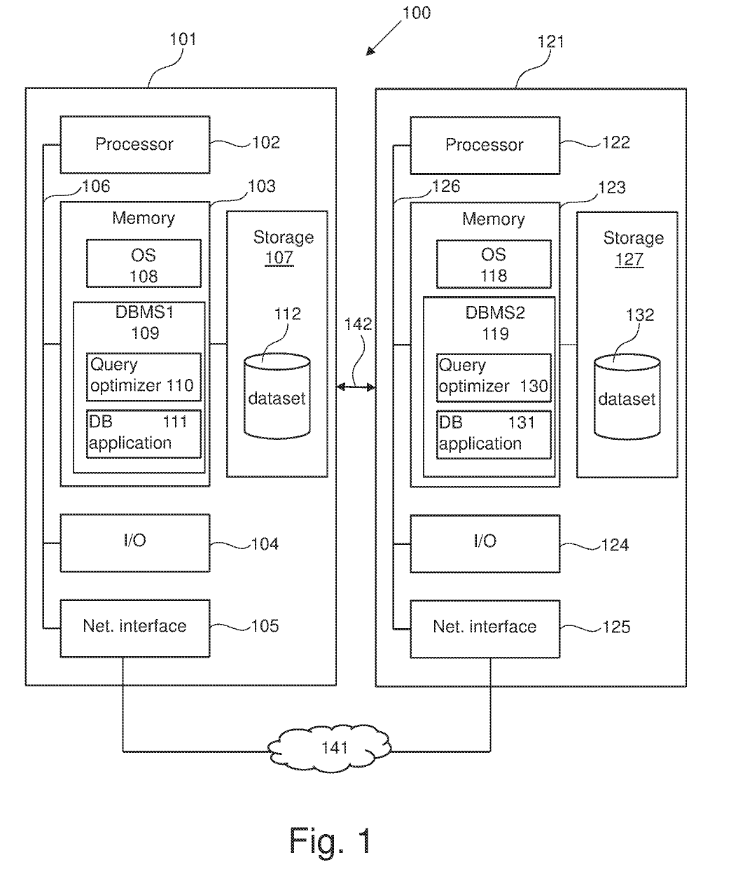

FIG. 1 is a block diagram for a data processing system 100 for a hybrid DBMS suited for implementing method operations as involved in the disclosure. The data processing system 100 includes a first computer system 101 (also referred to as transactional engine) connected to a second computer system 121 (also referred to as analytical engine or accelerator engine). The first computer system 101 may, for example, include an IBM System z. The second computer system 121 may, for example, include Netezza system. (Note: “IBM System z and/or Netezza may be subject to trademark rights and/or trademark registrations in various jurisdictions around the world.)

First computer system 101 includes processor 102, memory 103, I/O circuitry 104 and network interface 105 coupled together by bus 106.

Processor 102 may represent one or more processors (for example, microprocessors). The memory 103 can include any one or combination of volatile memory elements (for example, random access memory (RAM, such as DRAM, SRAM, SDRAM, etc.)) and nonvolatile memory elements (for example, ROM, erasable programmable read only memory (EPROM), electronically erasable programmable read only memory (EEPROM), programmable read only memory (PROM). Note that the memory 103 can have a distributed architecture, where various components are situated remote from one another, but can be accessed by the processor 102.

Memory 103 in combination with persistent storage device 107 may be used for local data and instruction storage. Storage device 107 includes one or more persistent storage devices and media controlled by I/O circuitry 104. Storage device 107 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like.

Memory 103 may include one or more separate programs, for example, database management system DBMS1 109, each of which includes an ordered listing of executable instructions for implementing logical functions, notably functions involved in embodiments of this invention. The software in memory 103 shall also typically include a suitable operating system (OS) 108. The OS 108 essentially controls the execution of other computer programs for implementing at least part of methods as described herein. DBMS1 109 includes a DB application 111 and a query optimizer 110. The DB application 111 may be configured for processing data stored in storage device 107. The query optimizer 110 may be configured for generating or defining query plans for executing queries, for example, on first dataset 112. The first dataset 112 may, for example, include transaction data that provides real time, or near real time, transaction data for OLTP analysis, such as postings from a manufacturing control system.

Second computer system 121 includes processor 122, memory 123, I/O circuitry 124 and network interface 125 coupled together by bus 126.

Processor 122 may represent one or more processors (for example, microprocessors). The memory 123 can include any one or combination of volatile memory elements (for example, random access memory (RAM, such as DRAM, SRAM, SDRAM, etc.)) and nonvolatile memory elements (for example, ROM, erasable programmable read only memory (EPROM), electronically erasable programmable read only memory (EEPROM), programmable read only memory (PROM). Note that the memory 123 can have a distributed architecture, where various components are situated remote from one another, but can be accessed by the processor 122.

Memory 123 in combination with persistent storage device 127 may be used for local data and instruction storage. Storage device 127 includes one or more persistent storage devices and media controlled by I/O circuitry 104. Storage device 127 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like.

Memory 123 may include one or more separate programs, for example, database management system DBMS2 119, each of which includes an ordered listing of executable instructions for implementing logical functions, notably functions involved in embodiments of this invention. The software in memory 123 shall also typically include a suitable OS 118. The OS 118 essentially controls the execution of other computer programs for implementing at least part of methods as described herein. DBMS2 119 includes a DB application 131 and a query optimizer 130. The DB application 131 may be configured for processing data stored in storage device 127. The query optimizer 130 may be configured for generating or defining query plans for executing queries, for example, on second dataset 132.

The first and second datasets 112 and 132 may be stored in different format. The formats may differ in compression, row-oriented vs. column-oriented storage, etc. The second dataset may be obtained from a source dataset. The source dataset set may include at least part of the first dataset.

For example, the second dataset 132 may be obtained by performing an Extract, Transform and Load (ETL) process on the source dataset. Data transformation may be accelerated using the second computer system 121 being for example a DB2 Analytic Accelerator. For example, data to be transformed does not necessarily have to be moved to another information integration server for transformation and cleansing purposes. These data can be transformed within the DB2 Analytics Accelerator.

In another example, the second dataset 132 may be obtained by replicating or copying the source dataset from the first computer system 101 to the second computer system 121. The second dataset 132 may include the attributes of the first dataset 112. For example, the second dataset 132 may include for a given attribute more attribute values than attribute values of the given attribute in the first dataset 112. At least part of the first dataset may include a proxy table. The proxy table may be used to access data in one or more corresponding database tables of the second dataset 132. The proxy table has all the attributes of one or more corresponding database tables, but does not contain data locally (for example, the proxy table may be a skeleton indicating at least the attributes of one or more databases but does not contains values of the attributes).

First computer system 101 and second computer system 121 may be independent computer hardware platforms communicating through a high-speed connection 142 or a network 141 via network interfaces 105, 125. The network 141 may, for example, include a local area network (LAN), a general wide area network (WAN), and/or a public network (for example, the Internet). Every computer system 101 and 121 is responsible for managing its own copies of the data.

Although shown in FIG. 1 as separate systems, the first and second computer systems may belong to a single system, for example, sharing a same memory and processor hardware, while each of the first and second computer systems is associated with a respective DBMS and datasets, for example, the two DBMSs may be stored in the shared memory. In another example, the two database management system DBMS1 and DBMS2 may form part of a single DBMS that enables communications and method performed by DBMS1 and DBMS2 as described herein. The first and second datasets may be stored on a same storage or on separate storages.

The data processing system 100 may for example categorize every incoming query and execute it on the engine that meets these characteristics best. The first computer system 101 may be responsible for efficient lookup in transactional workloads (OLTP) and may be optimized for accessing limited amounts of data for example, of the first dataset 112. The second computer system 121 may be responsible for data scans in the scope of analytical applications (OLAP), which require to read large amounts of data in a single query.

The second dataset 132 may, for example, include at least part of the first dataset 112 and further data. The further data is an accelerator only data since it is only stored on the analytical engine 121 and not stored on the transactional engine 101.

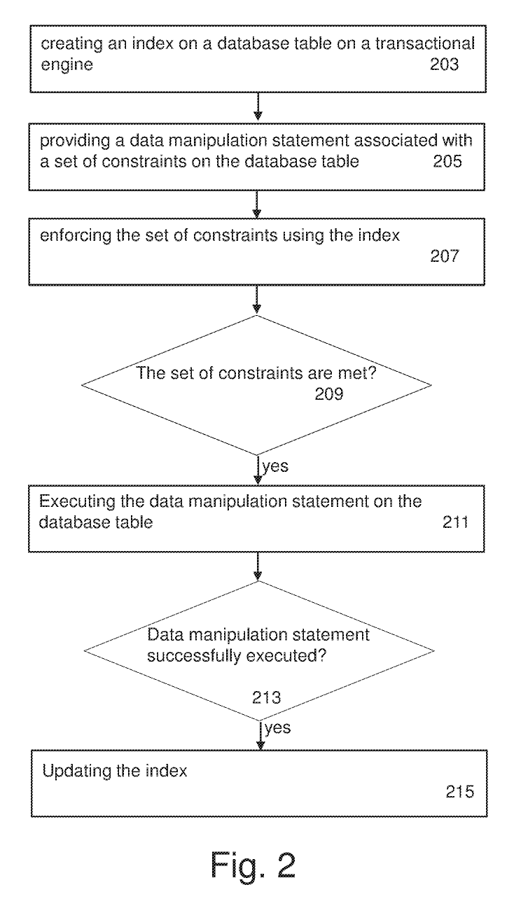

FIG. 2 is a flowchart of a method for enforcing a set of constraints on a database table 132. The database table may, for example, include at least part of the second dataset 132. The database table 132 is stored in the analytical engine 121 only. The set of constraints may, for example, include unique constraints and referential constraints. Unique constraints require the values in one or more columns to exist only once. Referential constraints require primary-to-foreign key references across tables to be met, so that a given primary key values in a first table must really exist when a foreign key in a second table refers to it.

In operation 203, an index is created on the database table 132 on the transactional engine 101. For that, the database table 132 stored on the analytical engine 121 is scanned for creating the index. For example, the transactional engine 101 may include a proxy table. The proxy table may include at least part of the first dataset 112. The proxy table 112 is used to access data in the database table 132 which is a remote table. The proxy table has all the attributes of the remote database table 132, but does not contain data locally.

In operation 205, a data manipulation statement associated with a set of constraints on the database table is provided. For example, the data manipulation statement may be triggered by, or caused by, or received from, one or more transactions at the transactional engine. In another example, the data manipulation statement may be part of a received data update request at the transactional engine.

The data manipulation statement may include an insert, update, or delete statement for inserting, updating or deleting one or more records respectively.

In operation 207, the transactional engine 101 enforces the set of constraints using the index in order to check if the data of the database table meet the set of constraints. The transactional engine may check, in operation 207, if the set of constraints are fulfilled or are met using the index.

In the case where the set of constraints are met (inquiry 209), the data manipulation statement is executed on the database table 132 at the analytical engine 121 in operation 211. The execution of operation 211 may further include committing by the analytical engine 121 the changes caused by the execution of the data manipulation statement. For example, in the case where the set of constraints are met, the transactional engine 101 may send to the analytical engine 121 the results of the check and/or a command to execute the data manipulation statement. Upon receiving the results and/or the command, the analytical engine 121 executes the data manipulation statement. If at least one constraint of the set of constraints is not met, the transaction of the data manipulation statement or the data manipulation statement may be aborted. The aborting may include ending the transaction.

In the case where (inquiry 213) the data manipulation statement is successfully executed, the index is updated in operation 215 in the transactional engine accordingly to the data manipulation statement. The index is updated to take into account the changes that have been induced to data by the execution of the data manipulation statement. If the execution of the data manipulation is not successful, the index may not be updated and a notification may be sent indicating the failure of executing the data manipulation statement.

In another example, the index may be updated before the execution of the data manipulation statement upon determining that the set of constraints are met. If the execution of the data manipulation is not successful, the modifications done to the index may be rolled back.

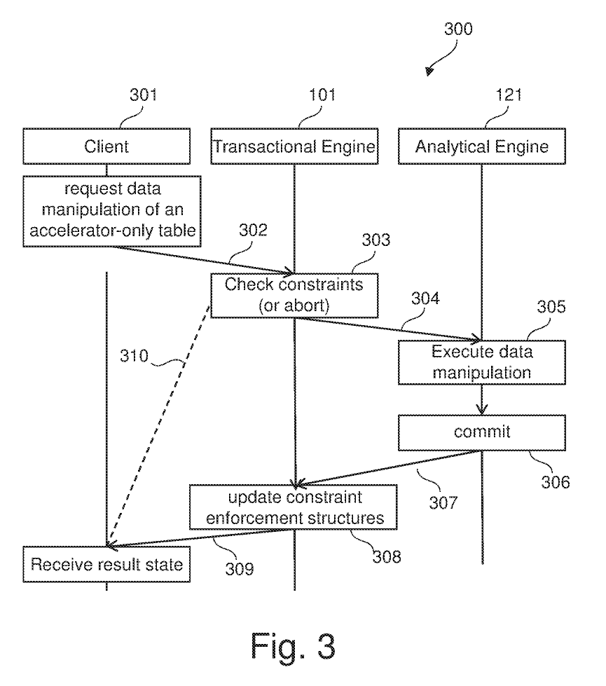

FIG. 3 is a flow diagram 300 for an example method for enforcing a set of constraints on a database table 132 in a data processing system, for example, 100. The database table 132 is an accelerator-only-table.

A client 301 (for example, client application) sends a request for data manipulation (302) to the transactional engine 101 on the database table 132. For example, the client 301 issues a data manipulation statement on an accelerator-only table (the database table) with defined set of constraints. The transactional engine 101 checks (303) the set of constraints using a constraints enforcement structure (for example, an index) on the database table that is stored in the transactional engine 101. If the set of constraints are met, the transactional engine 101 sends (304) to the analytical engine 121 a request, indication, or a data manipulation statement for executing the data manipulation on the database table by the analytical engine 121. The analytical engine 121 executes (305) the data manipulation on the database table upon receiving the request, or the indication from the transactional engine. The analytical engine 121 commits (306) the changes caused by the execution of the data manipulation. The analytical engine 121 may send (307) a message to the transactional engine 101 indicating that the execution of the data manipulation is successfully done. This may, for example, be done before or after the commit is performed. In response to the data manipulation being successfully executed, the transactional engine 101 updates (308) the index. The transactional engine 101 may send (309), upon updating the index, a message to the client 301 indicating the results of the execution of the data manipulation. It may, for example, indicate a successful execution of the data manipulation. However, if at least one constraint of the set of constraints is not met the transactional engine 101 may abort the execution of the data manipulation and may notify or send (310) a message accordingly to the client 301. The aborting of the data manipulation may include aborting the transaction that caused, or triggered, the data manipulation.

In another example, at the same time of sending (304) the data manipulation statement, the transactional engine 101 also updates the constraint enforcement data structures (indexes) according to the statement, if necessary. The analytical engine receives and executes the statement and notifies the transactional engine whether this succeeded. If the execution of the data manipulation by the analytical engine failed, then the transactional engine 101 may roll back the modifications done to the constraint enforcement data structures. In any case, the transactional engine reports the result back to the client 301.

The act of committing is the act of making of a set of tentative changes permanent.

Some embodiments of the present invention are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: (i) a portable computer diskette; (ii) a hard disk; (iii) a random access memory (RAM); (iv) a read-only memory (ROM); (v) an erasable programmable read-only memory (EPROM or Flash memory); (vi) a static random access memory (SRAM); (vii) a portable compact disc read-only memory (CD-ROM); (viii) a digital versatile disk (DVD); (ix) a memory stick; (x) a floppy disk; (xi) a mechanically encoded device such as punch-cards or raised structures in a groove having instructions recorded thereon; (xii) and/or any suitable combination of the foregoing. A computer readable storage medium, as used herein, is not to be construed as being transitory signals per se, such as: (i) radio waves or other freely propagating electromagnetic waves; (ii) electromagnetic waves propagating through a waveguide or other transmission media (for example, light pulses passing through a fiber-optic cable); and/or electrical signals transmitted through a wire.

Computer readable program instructions described herein can be downloaded to respective computing/processing devices from a computer readable storage medium or to an external computer or external storage device via: (i) a network, for example, the Internet; (ii) a local area network; (iii) a wide area network; (iv) and/or a wireless network. The network may include: (i) copper transmission cables; (i) optical transmission fibers; (ii) wireless transmission; (iii) routers; (iv) firewalls; (v) switches; (vi) gateway computers; and/or (vii) edge servers. A network adapter card, or network interface, in each computing/processing device receives computer readable program instructions from the network and forwards the computer readable program instructions for storage in a computer readable storage medium within the respective computing/processing device.

Computer readable program instructions for carrying out operations of the present invention may be: (i) assembler instructions; (ii) instruction-set-architecture (ISA) instructions; (iii) machine instructions; (iv) machine dependent instructions; (v) microcode; (vi) firmware instructions; (vii) state-setting data; or (viii) either source code or object code written in any combination of one or more programming languages, including an object oriented programming language such as: (a) Smalltalk; (b) C++ or the like; and (c) conventional procedural programming languages, such as the “C” programming language or similar programming languages. The computer readable program instructions may execute: (i) entirely on the user's computer; (ii) partly on the user's computer; (iii) as a stand-alone software package; (iv) partly on the user's computer and partly on a remote computer; or (v) entirely on the remote computer or server. In the latter scenario, the remote computer may be connected to the user's computer through any type of network, including: (i) a local area network (LAN); (ii) a wide area network (WAN) or (iii) an external computer (for example, through the Internet using an Internet Service Provider). In some embodiments, electronic circuitry including: (i) programmable logic circuitry; (ii) field-programmable gate arrays (FPGA); or (iii) programmable logic arrays (PLA), may execute the computer readable program instructions by utilizing state information of the computer readable program instructions to personalize the electronic circuitry, in order to perform aspects of the present invention.

Some embodiments of the present invention are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to: (i) a processor of a general purpose computer; (ii) a special purpose computer; and/or (iii) other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct: (i) a computer; (ii) a programmable data processing apparatus; and/or (iii) other devices to function in a particular manner, such that the computer readable storage medium having instructions stored therein includes an article of manufacture, including instructions which implement aspects of the function/act specified in the flowchart and/or block diagram block or blocks.

The computer readable program instructions may also be loaded onto: (i) a computer; (ii) other programmable data processing apparatus; or (iii) other device to cause a series of operations to be performed on: (a) the computer; (b) other programmable apparatus; or (c) other device to produce a computer implemented process, such that the instructions which execute on: (1) the computer; (2) other programmable apparatus; or (3) other device, implement the functions/acts specified in the flowchart and/or block diagram block or blocks.

The flowchart and block diagrams in the Figures illustrate the: (i) architecture; (ii) functionality and (iii) operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for enforcing constraints on a database table, the method comprising:
storing the database table on an analytical engine of a data processing system;
creating an index on the database table on a transactional engine of the data processing system, wherein the database table stored on the analytical engine is scanned for creating the index;
providing a data manipulation statement associated with a set of constraints on the database table;
successfully enforcing, by the transactional engine, the set of constraints based on the index; and
in response to the set of constraints being successfully enforced:
executing the data manipulation statement on the database table in the analytical engine, and
updating the index in the transactional engine accordingly to the data manipulation statement.

2. The method of claim 1, the updating of the index being performed in response to the data manipulation statement being executed.

3. The method of claim 1, further comprising:
in response to the set of constraints being successfully enforced sending, by the transactional engine, a request for executing the data manipulation statement to the analytical engine, the execution of the data manipulation statement being performed in response to receiving the request.

4. The method of claim 3, wherein the updating of the index is performed in parallel to the sending of the request.

5. The method of claim 3, further comprising:
determining that the execution of the data manipulation statement failed; and
responsive to the determination that the execution of the data manipulation statement filed, rolling back the modifications done to the index.

6. The method of claim 1, the index being implemented using a set of unique values of the database table which set of unique values are sufficient for enforcing the constraints.

7. The method of claim 1, the index identifying a storage location where the corresponding value is found in the database table on the analytical engine.

8. The method of claim 1, the database table being stored in the analytical engine only.

9. The method of claim 1, the set of constraints being on an attribute of the attributes of the database table, wherein the index comprises values of the attribute only.

10. The method of claim 1, executing data manipulation statement further comprising committing changes caused by the execution of the data manipulation statement.

11. The method of claim 1, the data processing system being a hybrid OLTP and OLAP database system, wherein the transactional engine is configured for performing OLTP processes, wherein the analytical engine is configured for performing OLAP processes.

12. A computer program product comprising a computer-readable storage medium having computer-readable program code embodied therewith, the computer-readable program code configured to implement the steps of the method according to claim 1.

13. A data processing system for enforcing constraints on a database table, the data processing system comprising a transactional engine and an analytical engine, the data processing system being configured for:
storing the database table on the analytical engine;
creating an index on the database table on the transactional engine, wherein the database table stored on the analytical engine is scanned for creating the index;
providing a data manipulation statement associated with a set of constraints on the database table;
successfully enforcing by the transactional engine the set of constraints based on the index; and
in response to the set of constraints being successfully enforced:
executing the data manipulation statement on the database table in the analytical engine, and
updating the index in the transactional engine accordingly to the data manipulation statement.

14. A method comprising:
storing a database table in an analytics engine of a data processing system;
providing a proxy table, without including actual data in the proxy table, corresponding to the database table on a transaction engine of the data processing system;
scanning the database table stored in the analytics engine to create, on the transactional engine, an index for the database table;
providing a data manipulation statement that defines a set of constraint(s) on the database table; and
enforcing, by the transactional engine the set of constraint(s) of the database manipulation statement based on the index.

15. The method of claim 14:
executing the data manipulation statement on the database table in the analytics engine.

16. The method of claim 15 further comprising:
updating the index in the transactional engine according to the data manipulation statement.

17. The method of claim 14 further comprising:
updating the index in the transactional engine according to the data manipulation statement.
